(19) United States
(12) Patent Application Publication
(10) Pub. No.: US 2026/0245248 A1
(43) Pub. Date: Aug. 20, 2026

(54) Predictive Digital Camera Self Leveling

(71) Applicant: Metrotech Corporation, Santa Clara, CA (US)

(72) Inventors: Johan David Overby, Los Gatos, CA (US); Diana Maria Solyom, San Jose, CA (US)

(21) Appl. No.: 19/054,663

(22) Filed: Feb. 14, 2025

(51) Int. Cl. G06T 7/80; G01N 21/954; G06T 7/00; H04N 21/234

(52) U.S. Cl. CPC G06T 7/80; G01N 21/954; G06T 7/0004; H04N 21/23418; G01N 2201/12761; G06T 2207/20081

(57) ABSTRACT

A method of providing a self-leveling camera video stream in a control module of a pipe inspection system includes receiving image data from a camera, the image data including sequential frames of video data; for each of the sequential frames of video data, separating a frame of video data from the image data, predicting a rotation angle of the camera for the frame of video data, and rotating the frame of video data to form a rotated video frame; forming a rotated video stream from sequential frames of the rotated video frame; and displaying a display image formed from the rotated video stream. In some embodiments, predicting a rotation angle includes using a machine learning algorithm on a sequence of video frames of the video data.

### TECHNICAL FIELD

Embodiments of the present invention are related to underground pipe inspection and, in particular, to an inspection camera with self-leveling functionality.

### DISCUSSION OF RELATED ART

Camera systems are often utilized for pipe inspections. In most systems, a camera is attached to a push-rod system which is flexible enough to navigate the twists and turns of a pipe and yet rigid enough to push the camera system through the pipe. The images from the camera can be transmitted through wiring in the push-rod system to a display, which allows an operator to diagnose issues such as blockages, cracks, and leaks in the pipe.

However, as the camera traverses the pipe, it may itself turn and tilt. This can cause disorientation to the operator, who may misinterpret and results of the video. Consequently, the operator is required to reorient themselves constantly to accurately assess the condition of the pipe being inspected.

Consequently, there is a need to develop self-leveling camera systems for use in pipe inspection systems.

### SUMMARY

According to some embodiments, a pipe inspection system is included. In some embodiments, a method of providing a self-leveling camera video stream in a control module of a pipe inspection system includes receiving image data from a camera, the image data including sequential frames of video data; for each of the sequential frames of video data, separating a frame of video data from the image data, predicting a rotation angle of the camera for the frame of video data, and rotating the frame of video data to form a rotated video frame; forming a rotated video stream from sequential frames of the rotated video frame; and displaying a display image formed from the rotated video stream. In some embodiments, predicting a rotation angle includes using a machine learning algorithm on a sequence of video frames of the video data. In some embodiments, the method can further include receiving accelerometer data from the image data. In some embodiments, the method can further include receiving tilt sensor data from the image data. In some embodiments, predicting a rotation angle of the camera includes determining the rotation angle of the camera using the accelerometer data or the tilt sensor data.

In some embodiments, the method further includes applying video compression to the rotated video stream to form a compressed video stream. In some embodiments, the method further includes transmitting the compressed video stream to a remote device or a storage device. In some embodiments, the display image is a sub-image of the rotated video stream. In some embodiments, the sub-image is a subset of the rotated video stream without cropping.

In some embodiments, a pipe inspection system is presented. In particular, the pipe inspection system includes a camera; a push rod coupled to the camera, the push rod guiding the camera through a pipe to be inspected; a spool on which the push rod is coiled; and a control module coupled to receive image data from the camera, the control module including a processor, a memory coupled to the processor, a camera interface coupled to the processor that receives the image data from the camera, and a user interface, wherein the processor is configured to receive image data from a camera, the image data including sequential frames of video data; for each of the sequential frames of video data, separate a frame of video data from the image data, predict a rotation angle of the camera for the frame of video data, and rotate the frame of video data to form a rotated video frame; form a rotated video stream from sequential frames of the rotated video frame; and display a display image formed from the rotated video stream.

In some embodiments, the processor executes a machine learning algorithm on a sequence of video frames of the video data to predict the rotation angle. In some embodiments, processor separates accelerometer data and/or tilt sensor data from the image data. In some embodiments, the processor determines the rotation angle of the camera using the accelerometer data and/or the tilt sensor data to predict the rotation angle.

In some embodiments, the processor can be configured to video compress the rotated video stream to form a compressed video stream. In some embodiments, the processor is configured to transmit, through a communications interface, the compressed video stream to a remote device or to a storage device.

In some embodiments, the display image is a sub-image of the rotated video stream. In some embodiments, the sub-image is a subset of the rotated video stream without cropping. These and other embodiments are discussed below with respect to the following figures.

### BRIEF DESCRIPTION OF THE FIGURES

FIG. 1 illustrates a pipe-inspection system according to some embodiments of the present disclosure.

FIG. 2 illustrates an example of a control module according to some embodiments of the present disclosure.

FIG. 3 illustrates operation of the control module according to some embodiments of the present disclosure.

FIG. 4 illustrates an example of a video frame received from a camera of the pipe-inspection system.

FIGS. 5A and 5B illustrate examples of the angular prediction function illustrated in FIG. 3 according to some embodiments of the present disclosure.

FIGS. 6A and 6B illustrates an example of the rotation function as illustrated in FIG. 3 according to some embodiments of the present disclosure.

FIG. 7 illustrates a method of performing the operation as illustrated in FIG. 3 according to some embodiments of the present disclosure.

These figures along with other embodiments are further discussed below.

### DETAILED DESCRIPTION

In the following description, specific details are set forth describing some embodiments of the present invention. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure.

This description illustrates inventive aspects and embodiments should not be taken as limiting—the claims define the protected invention. Various changes may be made without departing from the spirit and scope of this description and the claims. In some instances, well-known structures and techniques have not been shown or described in detail in order not to obscure the invention.

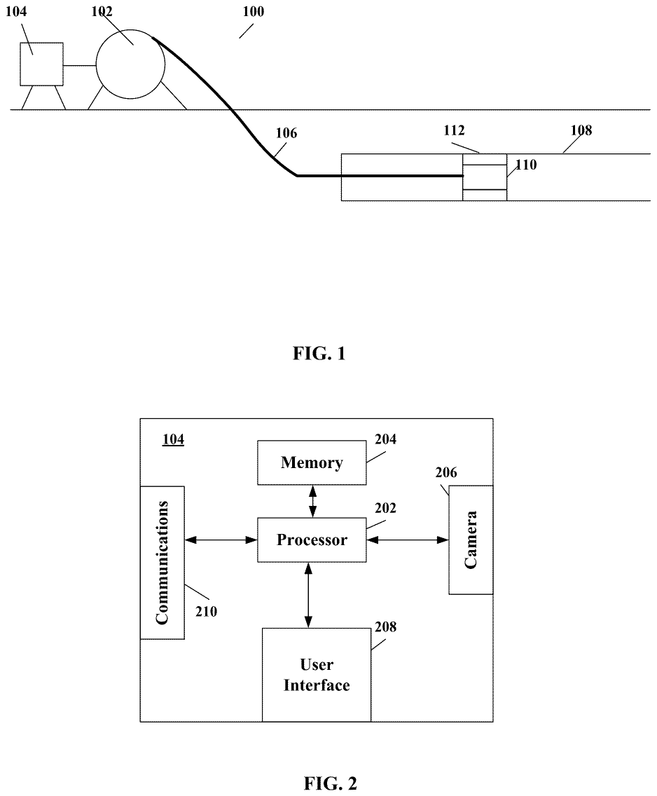

FIG. 1 illustrates a pipe inspection system 100 according to some embodiments of the present disclosure. Pipe inspection system 100 includes a reel 102, on which push rod 106 can be coiled. Reel 102 is coupled to a control module 104, which is coupled to receive image data from a camera 110 attached to push rod 106. As is illustrated in FIG. 1, push rod 106 with camera 110 can be inserted into a pipe 108. As shown, camera 110 can be inserted in a skid 112 which assists with keeping push rod 106 and camera 110 centered in pipe 108. Camera 110 can include lights to irradiate the interior of pipe 108 so that camera 110 can acquire images. The image data from camera is transmitted to control module 104, where the image data can be displayed on a screen or transmitted to another device for display. In some embodiments, the data images may be recorded for further study.

FIG. 2 illustrates an example of control module 104 that can operate according to embodiments of the present disclosure. As illustrated in FIG. 2, control module 104 includes a processor 202 coupled to a memory 204. Memory 204 can be any combination of volatile and non-volatile memory, including solid-state memory and fixed hard drives, that has sufficient capacity to hold instructions and data to perform the functions described below. Processor 202 can be any processing circuit capable of executing instructions stored in memory 204 to perform the functions described below. As such, processor 202 can be any combination of application specific integrated circuits (ASICs), microprocessors, microcontrollers, computers, or processors that execute the instructions to perform the described functions.

As is further illustrated in FIG. 2, processor 202 is coupled to a camera interface 206. As illustrated in FIG. 1, camera interface 206 can be connected, for example through push rod 106, to camera 110. As such, camera interface 206 receives image data from camera 110. Processor 202 can acquire the image data into a video stream and, in some embodiments, store the video stream in memory 204. As is discussed further below, processor 202 can process the image data as it arrives to provide a processed video stream.

Additionally, processor 202 is coupled to a user interface 208. User interface 208 can include a user input device (e.g., switches, touch screen interface, etc.) to provide control instructions to control module 104 as well as a screen on which the image data or video stream can be displayed.

Processor 202 can also be coupled to a communications interface 210. Communications interface 210 can include any combination of one or more communications modalities, for example wireless interfaces such as WiFi, Bluetooth, Cellular (5G, 4G, LTE, etc.) or wired connections to allow communications with remote devices, including mobile devices (e.g., laptops, smartphones, tablets) or communications with cloud-based applications.

In according to embodiments of the present disclosure, processor 202 receives the image data from camera 110 and digitally rotates the image so that the image that is produced in the processed video stream is continuously leveled as camera 110 is directed along pipe 108. A self-leveling camera offers several advantages during pipeline inspections, enhancing both the efficiency and accuracy of the process. A self-leveling camera maintains a consistent, upright orientation regardless of the pipe's twists and turns. This allows inspectors to easily interpret the video stream without needing to reorient themselves constantly. Accurate diagnosis of issues such as blockages, cracks, and leaks is facilitated by the stable and predictable view provided by a self-leveling camera. Using a video stream from a self-leveling camera reduces the changes of misinterpretation and ensures a precise assessment of the condition of the pipeline being inspected.

Current versions of self-leveling cameras use mechanical, digital camera rotation, or manual rotation driven by user inputs. In some versions, a self-leveling camera can be mechanically self-leveled. In this case, the camera can be held level by a pendulum using gravity. The pendulum mechanism for holding the camera level is the most common way of self-leveling inspection cameras. However, the mechanical bearings used in the mechanical pendulum system to allow the camera to rotate with the pendulum is prone to wear and causes problems over time. In another example, the camera can be held level with the use of a level sensor or accelerometer and a servo mechanism. This can reduce the weight of the bearings, but increases the complexity of the camera itself.

In another example, the camera can be servo controlled. The camera can include a level sensor or an accelerometer and a servo mechanism to keep the camera level. This can reduce the weight on the bearings in the camera, but greatly increases the complexity of the camera. Similarly, the camera may include an accelerometer and may include software to rotate the image acquired by the camera according to data from the accelerometer to transmit leveled image data. However, this process results in the loss of image data from the camera as it is being cropped by the software. Further, the process is computationally intensive and hard to perform by processors on the camera.

Embodiments of the present application provide a self-leveled image in control module 104 from the image data received at camera interface 206 while retaining the original image data for future use. Consequently, a leveled image can be presented to the operator from a camera 110 that does not include self-leveling capabilities while retaining all of the captured image data from camera 110. By leveraging the advanced computing resources available in control module 104 or in mobile devices that receive a streaming video stream based on the image data from control module 104, a leveled image can be presented to the operator in real time. In particular, control module 104 can execute instructions to estimate the rotational position of camera 110 to efficiently rotate the image data received by control module 104 before displaying the video to the operator. In some embodiments, camera 110 can include an accelerometer and/or tilt sensors where the data from the accelerometer and/or tilt sensors is included in the image data and used to help predict the rotation of camera 110.

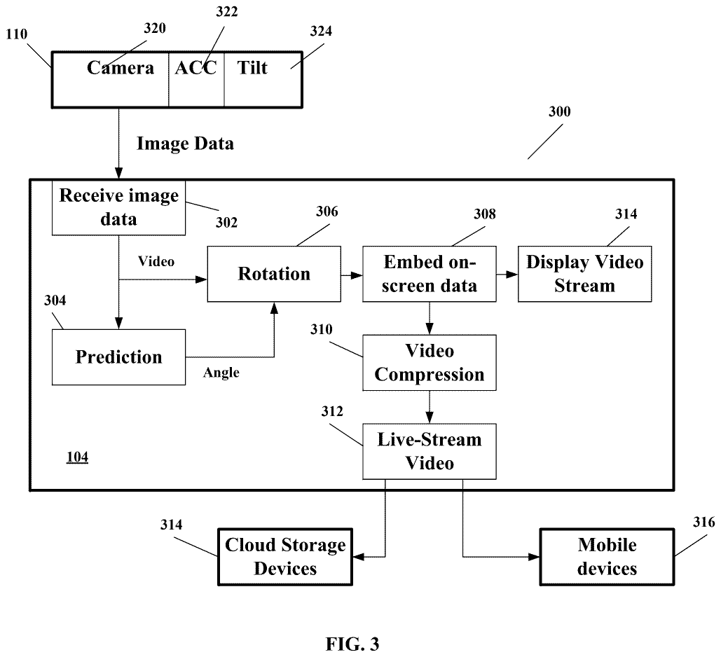

FIG. 3 illustrates operation of a control module 104 according to embodiments of the present disclosure. As illustrated in FIG. 3, camera 110 provides image data to control module 104, which is received in camera interface 206 as illustrated in FIG. 2. As is illustrated in FIG. 3, camera 110 includes camera portion 320 that provides video data. In some embodiments, camera 110 can include an accelerometer 322, which monitors the acceleration of camera 110 along multiple perpendicular axis. Data from accelerometer 322 can be used to determine the rotational and translational motion of camera 110 along pipe 108. In some embodiments, camera 110 can also include a tilt sensor 324. Data from tilt sensor 324 can be used to indicate the tilt of camera 110 relative to a horizontal orientation and may also be used to indicate the vertical orientation of the pipe section 108 through which camera 110 is traversing.

As is further illustrated in FIG. 3, control module 104 can be configured to transmit video streams to mobile device 316 or to cloud storage device 314 through communications interface 210 as illustrated in FIG. 2. FIG. 3 illustrates the instructions 300 performed within processor 202 of control module 204.

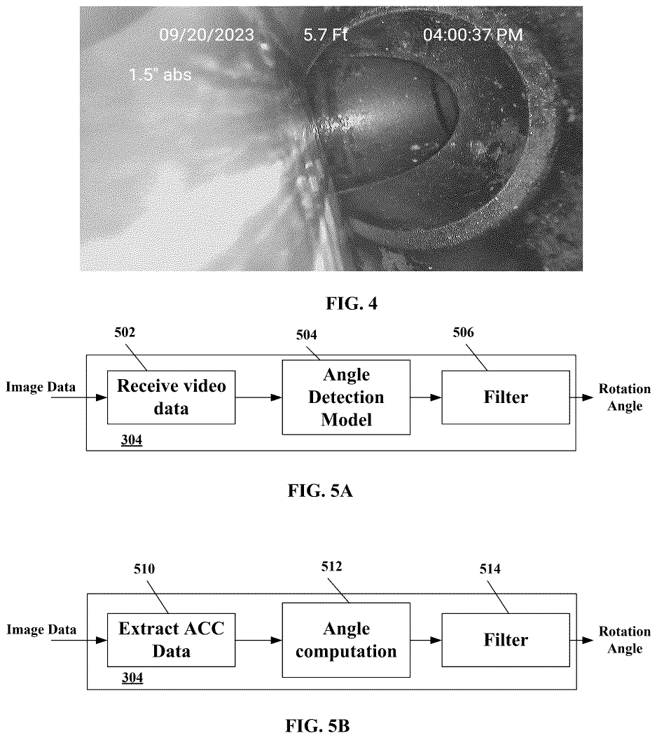

As illustrated in FIG. 3, image data from camera 110 is received in step 302. FIG. 4 illustrates an example of a frame of the video data included in the image data received in receive image data 302. In step 302, the sequential frames of the video data are separated from other data included in the image data and, in some cases, the image data and the video data may be buffered in memory 204 as illustrated in FIG. 2.

The video data is then input to a rotation function 306 and the image data is input to prediction function 304. Prediction function 304 predicts the angle of rotation of camera 110, frame by frame, with respect to a horizontal orientation of the camera. Consequently, rotation function 306 can rotate each frame of the video data by the predicted angle of rotation for that frame to arrive at a video stream that is leveled.

FIGS. 5A and 5B illustrate examples of prediction function 304 according to some embodiments of the present disclosure. FIG. 5A illustrates an example of prediction function 304 that uses a machine-learning (ML) model to identify the rotation based on the video data of the image data. As illustrated in FIG. 5A, in step 502, prediction function 304 receives the video data, which is a sequential sequence of video frames, from the image data. In step 504, an angle detection model using ML techniques can be used to determine the angle of rotation of camera 110 relative to the horizontal based on the video frames received. In particular, the ML algorithm monitors each video frame in sequence to determine the angle of rotation between frames and therefore the angular orientation of camera 110. In filter step 506, the rotation angle can be averaged over otherwise smoothed multiple frames of the video data in order to better predict a smooth rotation of the image.

In some cases, the section of pipe 108 through which camera 110 may not be completely horizontal and may have a significant vertical component, in some sections becoming completely vertical. The angle of rotation loses its meaning if the vertical component of the section of pipe 110 is too high. Consequently, in some embodiments if the pipe has a vertical component above a certain value, adjustments to the angle of rotation may be suspended until camera 110 reaches a section of pipe 108 with a sufficient horizontal component to continue. In some embodiments, the orientation of pipe 108 through which camera 110 is traversing can be determined from signals from accelerometer and/or signals from tilt sensor 324, which may include sensors oriented to measure the tilt rotation of camera 110 and the traverse orientation of camera 110.

FIG. 5B illustrates an example of prediction function 304 where camera 110 includes accelerometer 322. As shown in FIG. 5B, prediction function 304 extracts the accelerometer data and the tilt sensor data from the image data in extract function 510. The current rotational angle of camera 110 can be determined from the ACC data in angle computation function 512. Angle computation function 512 can predict the angular rotation of camera 110 based on the ACC data. In step 514, as discussed above, the rotation angle is averaged over multiple frames of the video data to smooth the rotational changes.

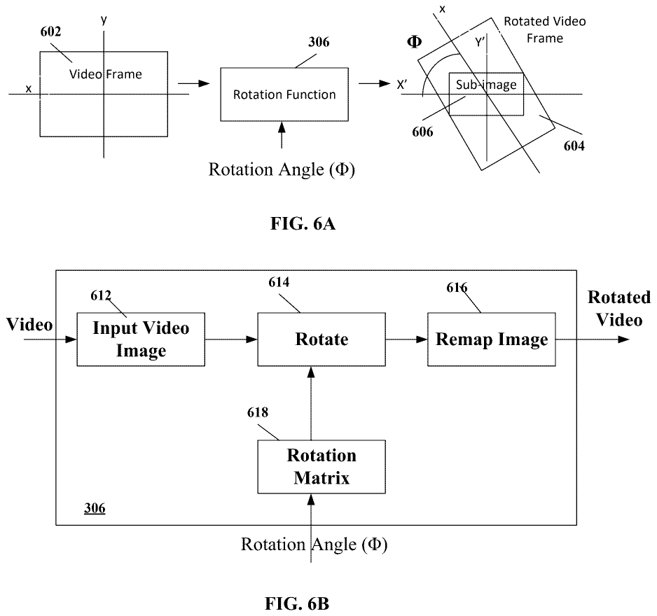

As shown in FIG. 3, the video data and the rotational angle is input to rotation function 306. Rotation function 306 is further illustrated in FIGS. 6A and 6B. FIG. 6A illustrates rotation function 306. As illustrated in FIG. 6A, video data in the form of a series of video frames 602. Each of the video frames 602 is rotated by the rotation angle @ rotation function 306 to create a rotated video frame 604. As is further illustrated, a sub-image 606 can be displayed, which is the self-leveled image. The cropping issue discussed above is avoided in embodiment of the present disclosure by arranging the image boundary of sub-image 606 to be fully contained within the rotated video frame 604. In some embodiments, video frame 602 can be high-resolution frames so that the resolution of sub-image 606 is sufficient to resolve and analyze the condition of pipe 108.

FIG. 6B further illustrates rotation function 306. As illustrated in FIG. 6B, video data (i.e. serial video frames 602) is input to input video image 612. As is illustrated in FIG. 6A, video frame can be characterized by the function Vᵢₙ(x,y), where Vᵢₙ(x,y) is the video data as a function of the x-coordinate and the y-coordinate. As shown in FIG. 6A, the x-coordinate and y-coordinate are defined relative to a central intersection point (x,y)=(0,0) shown. The rotation will be about an axis perpendicular to the x-axis and the y-axis at the point (0,0). In some embodiments, as is illustrated in FIG. 4, the video data may be grey scale and the function Vᵢₙ(x,y) is a grey scale parameter for each location parameter (x, y). The input video data from input video image 612 (V (x,y)) is input to rotate 614. Although the image Vᵢₙ(x,y) is illustrated as a rectangular image, it may also be a circular image that is taken by camera 110.

The rotation angle Φ generated by prediction function 304 is input to rotation matrix 618 of rotation function 306. Rotation matrix 618 generates a rotation matrix R, where the rotation matrix R is given by

$$\overleftrightarrow{R} = [ \begin{matrix}cos ( ∅ ) & - sin ( ∅ ) \\ sin ( ∅ ) & cos ( ∅ )\end{matrix} ]$$

In rotate 614, the rotation matrix R is used to rotate the (x,y) coordinates in video frame 602 to the (x′, y′) coordinates in rotated image 604. As such, the output coordinates are given by

$$( {x}^{′} , {y}^{′} ) = {C}_{out} ( x , y , ∅ ) = \overleftrightarrow{R} ( \begin{matrix}x \\ y\end{matrix} ) = [ \begin{matrix}cos ( ∅ ) & - sin ( ∅ ) \\ sin ( ∅ ) & cos ( ∅ )\end{matrix} ] [ \begin{matrix}x \\ y\end{matrix} ]$$

In step 616, the image Vᵢₙ(x,y) is then mapped to the output image Vₒᵤₜ(x′,y′). The rotated video frame is rotated around the rotational axis and a sub-image 606 can be extracted from the output image Vₒᵤₜ(x′,y′).

Returning to FIG. 3, from rotation function 306 the rotated image Vₒᵤₜ(x′,y′) is input to embed function 308, where further data is embedded onto sub-image 606 for display. Such embedded data can, for example, be the date and time of image capture, customer data, length along the pipe, or other data. In step 314, the sub-image 606 can be displayed on user interface 208.

Additionally, the rotated image with the embedded data can be sent from embed function 308 to video compression 310, where the video data is compressed using any of a variety of known video compression techniques. The compressed video data is input to streaming video 312, where the compressed video stream is communicated to devices outside of control module 104 through communications interface 210 as illustrated in FIG. 2.

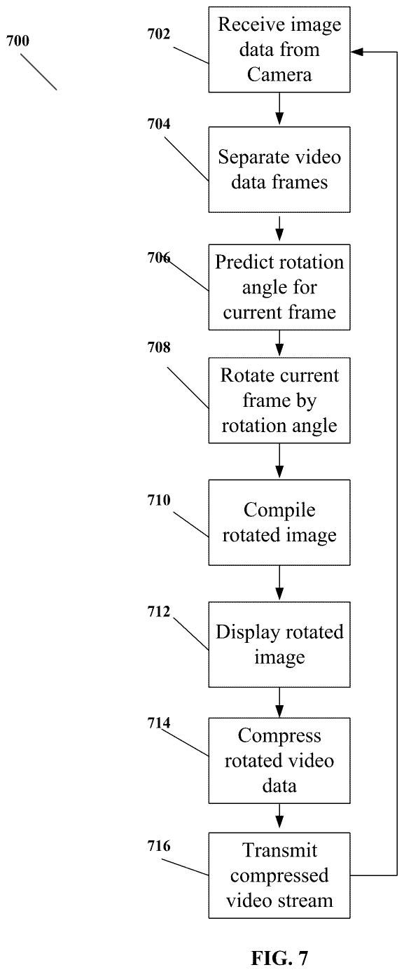

FIG. 3 illustrates the functionality of control module 104. As such, each of the functions within control module 104 are executed within processor 202 as illustrated in FIG. 2. The functions can be executed by any combination of dedicated components (e.g., video processors, microcontrollers, microcomputers, processing chips, ASICs, or other components). In some embodiments, the functionality of control module 104 may be executed in a microprocessor or microcomputer in processor 202. FIG. 7 further illustrates a method 700 executed in a microprocessor or microcomputer of processor 202 of control module 104.

As illustrated in FIG. 7, method 700 starts at step 702, where the image data from camera 110 can be received. In some embodiments, the image data received from camera 110 can digital data or digitized in camera interface 206 and can be buffered or recorded in memory 204 prior to or during processing by method 700. In step 704, the video data frames are separated from other data that may be transmitted in the image data. In some embodiments, for example, image data may include accelerometer ACC data, tilt sensor data, or other related data associated with the survey. Steps 702 and 704 may perform the steps of receive function 302 as illustrated in FIG. 3 and may employ camera interface 206 and processor 202 as illustrated in FIG. 2.

In step 706, the rotation angle for the current video frame is predicted. As discussed above with respect to prediction function 304, the rotation angle of camera 110 can be predicted from the sequence of video frames using machine learning as illustrated in FIG. 5A or can be predicted using the accelerometer data and tilt sensor data from camera 110. The current video frame is then rotated in step 708, as is discussed with respect to rotation function 306 and as described with FIGS. 6A and 6B. The rotated frame results in a leveled image, or sub-image, of the original video frame. As discussed above, if the vertical component of the section of pipe 108 through which camera 110 is traversing is above a threshold value, the rotation angle is fixed until the vertical component is below the threshold value. In some cases, the threshold value can include a high and low value to provide hysteresis such that the rotation angle is fixed on the high threshold value of vertical component and recalculated when the vertical component decreases below the low value of the threshold value.

The sequence of leveled images can then be compiled into a rotated video in step 710 and the resulting leveled video displayed on user interface 208 in step 712. As is described in FIG. 3, in some embodiments step 710 can include function 308, which embeds data into the leveled images prior to compilation of the sequential frames into a video and displayed in step 712 on user interface 208.

In step 714, the rotated image can be compressed using any of a variety of video compression algorithms. In step 716, the compressed video can be transmitted through communications interface 210, for example to a mobile device 316 or to a cloud storage device 314 as illustrated in FIG. 3.

Aspect 1: A method of providing a self-leveling camera video stream in a control module of a pipe inspection system, comprising: receiving image data from a camera, the image data including sequential frames of video data; for each of the sequential frames of video data, separating a frame of video data from the image data, predicting a rotation angle of the camera for the frame of video data, and rotating the frame of video data to form a rotated video frame; forming a rotated video stream from sequential frames of the rotated video frame; and displaying a display image formed from the rotated video stream.

Aspect 2: The method of Aspect 1, wherein predicting a rotation angle includes using a machine learning algorithm on a sequence of video frames of the video data.

Aspect 3: The method of any of Aspects 1 or 2, further including receiving accelerometer data from the image data.

Aspect 4: The method of any of Aspects 1-3, further including receiving tilt sensor data from the image data.

Aspect 5: The method of any of Aspects 1-4, wherein predicting a rotation angle of the camera includes determining the rotation angle of the camera using the accelerometer data.

Aspect 6: The method of any of Aspects 1-5, wherein predicting a rotation angle of the camera includes determining the rotation angle of the camera using the tilt sensor data.

Aspect 7: The method of any of Aspects 1-6, further including applying video compression to the rotated video stream to form a compressed video stream.

Aspect 8: The method of any of Aspects 1-7, further including transmitting the compressed video stream to a remote device.

Aspect 9: The method of one of Aspects 1-8, further including transmitting the compressed video stream to a storage device.

Aspect 10: The method of any of Aspects 1-9, wherein the display image is a sub-image of the rotated video stream.

Aspect 11: The method of any of Aspects 1-10, wherein the sub-image is a subset of the rotated video stream without cropping.

Aspect 12: A pipe inspection system, comprising: a camera; a push rod coupled to the camera, the push rod guiding the camera through a pipe to be inspected; a spool on which the push rod is coiled; and a control module coupled to receive image data from the camera, the control module including a processor, a memory coupled to the processor, a camera interface coupled to the processor that receives the image data from the camera, and a user interface, wherein the processor is configured to receive image data from a camera, the image data including sequential frames of video data; for each of the sequential frames of video data, separate a frame of video data from the image data, predict a rotation angle of the camera for the frame of video data, and rotate the frame of video data to form a rotated video frame; form a rotated video stream from sequential frames of the rotated video frame; and display a display image formed from the rotated video stream.

Aspect 13: The system of Aspect 12, wherein to predict a rotation angle, the processor executes a machine learning algorithm on a sequence of video frames of the video data.

Aspect 14: The system of any of Aspects 12-13, further including the processor separating accelerometer data from the image data.

Aspect 15: The system of any of Aspects 12-14, further including the processor separating tilt sensor data from the image data.

Aspect 16: The system of any of Aspects 12-15, wherein to predict the rotation angle, the processor determines the rotation angle of the camera using the accelerometer data.

Aspect 17: The system of any of Aspects 12-16, wherein to predict the rotation angle, the processor determines the rotation angle of the camera using the tilt sensor data.

Aspect 18: The system of any of Aspects 12-17, further including the processor configured to video compress the rotated video stream to form a compressed video stream.

Aspect 19: The system of any of Aspects 12-18, further including the processor configured to transmit, through a communications interface, the compressed video stream to a remote device.

Aspect 20: The system of any of Aspects 12-19, further including the processor configure to transmit, through a communications interface, the compressed video stream to a storage device.

Aspect 21: The system of any of Aspects 12-20, wherein the display image is a sub-image of the rotated video stream.

Aspect 22: The system of any of Aspects 12-21, wherein the sub-image is a subset of the rotated video stream without cropping.

The above detailed description is provided to illustrate specific embodiments of the present invention and is not intended to be limiting. Numerous variations and modifications within the scope of the present invention are possible. The present invention is set forth in the following claims.

What is claimed is:

1. A method of providing a self-leveling camera video stream in a control module of a pipe inspection system, comprising:
receiving image data from a camera, the image data including sequential frames of video data;
for each of the sequential frames of video data,
separating a frame of video data from the image data,
predicting a rotation angle of the camera for the frame of video data, and rotating the frame of video data to form a rotated video frame;
forming a rotated video stream from sequential frames of the rotated video frame; and
displaying a display image formed from the rotated video stream.

2. The method of claim 1, wherein predicting a rotation angle includes using a machine learning algorithm on a sequence of video frames of the video data.

3. The method of claim 1, further including receiving accelerometer data from the image data.

4. The method of claim 1, further including receiving tilt sensor data from the image data.

5. The method of claim 3, wherein predicting a rotation angle of the camera includes determining the rotation angle of the camera using the accelerometer data.

6. The method of claim 4, wherein predicting a rotation angle of the camera includes determining the rotation angle of the camera using the tilt sensor data.

7. The method of claim 1, further including applying video compression to the rotated video stream to form a compressed video stream.

8. The method of claim 7, further including transmitting the compressed video stream to a remote device.

9. The method of claim 7, further including transmitting the compressed video stream to a storage device.

10. The method of claim 1, wherein the display image is a sub-image of the rotated video stream.

11. The method of claim 10, wherein the sub-image is a subset of the rotated video stream without cropping.

12. A pipe inspection system, comprising:
a camera;
a push rod coupled to the camera, the push rod guiding the camera through a pipe to be inspected;
a spool on which the push rod is coiled; and
a control module coupled to receive image data from the camera, the control module including
a processor,
a memory coupled to the processor,
a camera interface coupled to the processor that receives the image data from the camera, and
a user interface,
wherein the processor is configured to
receive image data from a camera, the image data including sequential frames of video data;
for each of the sequential frames of video data,
separate a frame of video data from the image data,
predict a rotation angle of the camera for the frame of video data, and
rotate the frame of video data to form a rotated video frame;
form a rotated video stream from sequential frames of the rotated video frame; and
display a display image formed from the rotated video stream.

13. The system of claim 12, wherein to predict a rotation angle, the processor executes a machine learning algorithm on a sequence of video frames of the video data.

14. The system of claim 12, further including the processor separating accelerometer data from the image data.

15. The system of claim 12, further including the processor separating tilt sensor data from the image data.

16. The system of claim 14, wherein to predict the rotation angle, the processor determines the rotation angle of the camera using the accelerometer data.

17. The system of claim 15, wherein to predict the rotation angle, the processor determines the rotation angle of the camera using the tilt sensor data.

18. The system of claim 12, further including the processor configured to video compress the rotated video stream to form a compressed video stream.

19. The system of claim 18, further including the processor configured to transmit, through a communications interface, the compressed video stream to a remote device.

20. The system of claim 18, further including the processor configure to transmit, through a communications interface, the compressed video stream to a storage device.

21. The system of claim 12, wherein the display image is a sub-image of the rotated video stream.

22. The system of claim 21, wherein the sub-image is a subset of the rotated video stream without cropping.
